(19) United States
(12) Patent Application Publication
(10) Pub. No.: US 2023/0246214 A1
(43) Pub. Date: Aug. 3, 2023

(54) METHOD FOR PRODUCTION OF AN AT LEAST TWO-LAYERED LAMINATE OF A MEMBRANE ELECTRODE ASSEMBLY

(71) Applicant: AUDI AG, Ingolstadt (DE)

(72) Inventor: Daniela KÖNNICKE, Neudenau (DE)

(21) Appl. No.: 18/001,855

(22) PCT Filed: Jun. 17, 2021
(86) PCT No.: PCT/EP2021/066384

§ 371 Date: Dec. 14, 2022

(30) Foreign Application Priority Data
Sep. 22, 2020 (DE) 102020124576.9

(51) Int. Cl. H01M 8/1004; H01M 8/1039

(52) U.S. Cl. CPC H01M 8/1004; H01M 8/1039; H01M 2008/1095

(57) ABSTRACT

A method for production of an at least two-layered laminate of a membrane electrode assembly for a fuel cell comprises: preparing a membrane material from a proton-conducting electrolyte, preparing an electrode material comprising at least one catalyst, applying a liquid adhesive on a surface of the membrane material and/or on a surface of the electrode material, and contacting the surfaces of the membrane material and the electrode material to form a material connection by means of the liquid adhesive, wherein additionally a production aid is introduced into or applied onto an assemblage formed from the electrode material, the membrane material and the still unhardened liquid adhesive, the production aid being designed to stabilize the unhardened assemblage.

### BACKGROUND

### Technical Field

Embodiments of the invention relate to a method for production of an at least two-layered laminate of a membrane electrode assembly (MEA) for a fuel cell.

### Description of the Related Art

Fuel cell devices are used for the chemical transformation of a fuel with oxygen to form water, in order to generate electrical energy. For this, fuel cells contain as their core component a proton-conducting (electrolyte) membrane, which is associated with electrodes and thus forms a common membrane electrode assembly (MEA). In the operation of the fuel cell device having a plurality of fuel cells assembled into a fuel cell stack, the fuel, especially hydrogen (H₂) or a hydrogen-containing gas mixture is supplied to the anode. In the case of a hydrogen-containing gas, the gas is at first reformed, thus providing hydrogen. At the anode, an electrochemical oxidation of H₂ to H⁺ occurs, giving off electrons. The electrons provided at the anode are taken by an electrical conduit to the cathode. The cathode is supplied with oxygen or an oxygen-containing gas mixture, so that a reduction of O₂ to O²⁻ occurs, taking up the electrons.

It is known how to join the individual components of the membrane electrode assembly into a composition in discrete, i.e., individual steps, wherein the element joining the components is formed from a glue in the form of a liquid adhesive, which upon hardening at the same time separates the anode side from the cathode side in gas-tight manner. This liquid adhesive requires a certain time in the production process to harden and thus to possess the necessary stability, especially for a handling of the composition of the membrane electrode assembly.

WO 2006/047 950 A1 describes the production of a membrane electrode assembly together with gas diffusion layers, which are joined in a hot press to form a composition. In the hot press, a hot-melt glue strip is melted until it becomes cross-linked and hardens. WO 2013/178 987 A1 describes a method for the assembling of a fuel cell stack, during which a prefabricated membrane electrode assembly having a gas diffusion layer attached to it (a so-called four-layer MEA) is materially joined by a glue strip to another gas diffusion layer and a bipolar plate. EP 1 772 922 A1 describes the making of an electrode layer for a membrane electrode assembly of a fuel cell, wherein the electrode layer contains a polymer binder, which is bound to the catalyst particles by means of a plasma, by UV irradiation, or by gamma irradiation.

DE 10 2016 006 225 A1 shows a method for producing a product from at least two components connected to one another by means of at least one adhesive, with a first quantity of adhesive being applied to a first component. US 2013/0306237A1 describes a jig for fixing laminated materials and a method for manufacturing laminated materials, for example for manufacturing a membrane-electrode assembly. In this case, a proton-conductive electrolyte and two electrodes comprising a catalyst layer are mounted in the jig and hot-pressed, wherein an element for stabilizing the uncured layers can be introduced between the layers.

### BRIEF SUMMARY

Some embodiments provide a method for the production of an at least two-layered laminate of a membrane electrode assembly which can be handled safety during large-scale manufacture of the fuel cells, and which can withstand greater forces during the handling on account of the shorter cycle times for the production of the individual components.

The method, in some embodiments, for production of an at least two-layered laminate of a membrane electrode assembly (MEA) for a fuel cell involves in particular the following steps:

preparing a membrane material from a proton-conducting electrolyte,

preparing an electrode material comprising at least one catalyst,

applying a liquid adhesive on a surface of the membrane material and/or on a surface of the electrode material, and

contacting the surfaces of the membrane material and the electrode material to form a material connection by means of the liquid adhesive, wherein additionally a production aid is introduced into or applied onto an assemblage formed from the electrode material, the membrane material and the still unhardened liquid adhesive, the production aid being designed to stabilize the unhardened assemblage.

Thus, in this way an additional production aid is used to provide enhanced stability and therefore an improved handling of the still unhardened overall assemblage. The production aid is placed onto the unhardened assemblage or also introduced or inserted between the individual layers of the assemblage. Thus, it is possible in this way to produce the membrane electrode assembly in a continuous process, for example in a “roll to roll” production, as is known for example in newspaper printing.

In this context, it is further possible to also provide another electrode material containing at least one catalyst, which is placed on an opposite surface of the membrane or the membrane material and fixed by means of liquid adhesive, thereby applying a cathode material on both sides of the membrane material. An additional production aid can also be introduced on the side with the additional cathode material, and the production aid can also be integrated between the individual layers of the still unhardened membrane electrode assembly.

The production aid for stabilizing the unhardened assemblage may be applied in a marginal area situated away from the active region of the membrane electrode assembly. In this way, it is thus possible for the active region, i.e., the region in which the actual fuel cell reaction takes place, to remain free of the production aid, so that this does not adversely affect the flow of process gases. Instead, the production aid thanks to being placed in a marginal area can also be utilized to give the membrane electrode assembly an enhanced tightness to media, since it can also act in part as an edge seal.

The possibility exists for the production aid for stabilizing the unhardened assemblage to be applied in a spot. In this way, only a slight material expense is needed for the production aid, but at the same time this assures a safe and stabilized bonding with unhardened liquid adhesive. Alternatively or additionally, the production aid for stabilizing the unhardened assemblage can also be applied on a surface, such that the entire marginal region, i.e., the region of the membrane electrode arrangement lying away from the active region, can be covered flat by the production aid. This results in a further stabilization and a further sealing, for example, also a sealing against escape of the liquid adhesive when handling the unhardened assemblage. Alternatively or additionally, the production aid can also be applied in a line, so that an additional sealing can also occur here.

The production aid can be applied for example by a mechanical connection, such as a clamping or a crimping on the unhardened assemblage.

In some embodiments, the production aid may be in the form of a joining agent for the firmly bonded connection to the membrane material and/or to the electrode material, which has a shorter curing time compared to the liquid adhesive. Thus, in addition to the liquid adhesive, another joining agent is provided by the production aid, which, however, cures more quickly and thus offers more quickly a stabilization function for the still uncured composite with the liquid adhesive.

In this regard, the joint compound may be a UV-hardening adhesive and the joint compound may be hardened under UV light even before the liquid adhesive is hardened. When a UV-hardening adhesive is used, one can likewise achieve an especially simple mass production of the membrane electrode assemblies, since they can easily move through drying chambers and thus a weblike membrane material can be coated with a weblike catalyst electrode material.

The possibility also exists for the joint compound to be a pressure sensitive adhesive in the form of an adhesive tape, which is applied to one or both surfaces away from the liquid adhesive. The use of an adhesive tape affords the advantage that this is already dry, and it can also be formed in particular as a two-sided adhesive tape in order to provide an additional joining of the membrane material and the electrode material.

Furthermore, the possibility exists for the joint compound to be a hot melt glue which liquefies under the action of heat and hardens again even before the liquid adhesive has hardened. In this way, the hot melt glue becomes cross-linked with the surfaces of the membrane material and the electrode material and hardens, and thanks to this “prehardening” of the liquid adhesive it is not possible for it to harden only at a later time, so that the prefabricated membrane electrode assembly can already undergo further process steps at an early time.

One adhesive which is especially fast drying and advantageous for the material selection of the individual components of the MEA is a cyanate acrylate adhesive. This hardens much faster than the liquid adhesive.

Moreover, the possibility also exists for the joint compound to form a laminate connection which hardens even before the liquid adhesive.

Alternatively or additionally, the production aid may comprise a frame, which is placed on or integrated in the unhardened assemblage, and the frame may be melted at one spot and/or on a surface and/or in a line, especially by using a laser, and it may harden again even before the liquid adhesive hardens. Thus, in this way, the frame can be melted, so that it becomes cross-linked with one or the other surface of the membrane material or the electrode material and binds to it in a material connection after hardening. Thanks to the use of this frame, an additional stability is provided, facilitating the handling of the prefabricated membrane electrode assembly with still fluid or unhardened liquid adhesive.

In order to carry out the manufacturing steps as quickly as possible, a production aid has proven to be advantageous which remains in the assemblage of the membrane electrode assembly after the hardening of the liquid adhesive. Yet the possibility also exists of the production aid being removed from the assemblage once again before or during the combining of a plurality of membrane electrode assemblies to form a fuel cell stack.

The features and combinations of features mentioned above in the specification and also the features and combinations of features mentioned below in the description of the figures and/or shown only in the figures can be used not only in the particular indicated combination, but also in other combinations or standing alone. Thus, embodiments not explicitly shown or discussed in the figures, yet which emerge from and can be created from the explained embodiments by separate combinations of features should be seen as also being encompassed and disclosed by the present disclosure.

### BRIEF DESCRIPTION OF THE SEVERAL VIEWS OF THE DRAWINGS

Further benefits, features and details will emerge from the claims, the following description of embodiments, and the drawings.

FIG. 1 shows a schematic representation of a layout of a fuel cell having a three-part laminate of a membrane electrode assembly (MEA).

### DETAILED DESCRIPTION

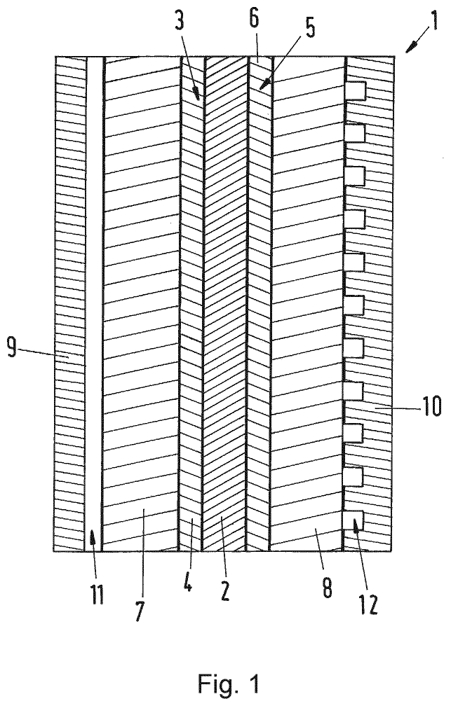

FIG. 1 shows a fuel cell 1. A semipermeable electrolyte membrane 2 here is covered with and materially joined to a first electrode 4 on a first side 3, in the present case the anode, and on a second side 5 with a second electrode 6, in the present case the cathode. The electrodes 4, 6 and the membrane 2 form a composition of a so-called membrane electrode assembly (MEA). The first electrode 4 and the second electrode 6 comprise substrate particles 14, on which catalyst particles of precious metals or mixtures containing precious metals such as platinum, palladium, ruthenium or the like are arranged or substrated. These catalyst particles serve as reaction accelerants in the electrochemical reaction of the fuel cell 1. The substrate particles may contain carbon. Yet substrate particles may also be considered which are formed from a metal oxide or carbon with an appropriate coating. The electrodes 4, 6 may be formed with a multitude of catalyst particles, which can be formed as nanoparticles, such as “core-shell nanoparticles.” These have the advantage of a large surface, while the precious metal or the precious metal alloy is arranged only on the surface, and a less valuable metal, such as nickel or copper, forms the core of the nanoparticle. In such a polymer electrolyte membrane fuel cell (PEM fuel cell), fuel or fuel molecules, especially hydrogen, are split up into protons and electrons at the first electrode 5 (anode). The electrolyte membrane 2 lets through the protons (e.g., H⁺), but is impenetrable to the electrons (e). The electrolyte membrane 2 in this embodiment is formed from an ionomer, such as a sulfonated tetrafluorethylene polymer (PTFE) or a polymer of perfluorinated sulfonic acid (PFSA). At the anode, the following reaction occurs: 2H₂→4H⁺+4e⁻ (oxidation/electron surrender). While the protons pass through the electrolyte membrane 2 to the second electrode 6 (cathode), the electrons are taken by an external circuit to the cathode or to an energy accumulator. At the cathode, a cathode gas is provided, especially oxygen or oxygen-containing air, so that the following reaction occurs here: O₂+4H⁺+4e⁻→2H₂O (reduction/electron uptake). In the present case, the electrodes 4, 6 are each associated with a gas diffusion layer 7, 8, one gas diffusion layer 7 being associated with the anode and the other gas diffusion layer 8 with the cathode. Moreover, the anode-side gas diffusion layer 7 is associated with a flow field plate, shaped as a bipolar plate 9, for supply of the fuel gas, having a fuel flow field 11. By means of the fuel flow field 11, the fuel is supplied through the gas diffusion layer 7 to the electrode 4. At the cathode side, the gas diffusion layer 8 is associated with a flow field plate having a cathode gas flow field 12, likewise shaped as a bipolar plate 10, for supply of the cathode gas to the electrode 6.

The membrane electrode assembly (MEA) as described herein need not be produced in discrete steps, nor is it necessary to wait for the individual components to be bonded firmly together during the material joining with a liquid adhesive before the membrane electrode assembly is further processed. Thus, the embodiments described herein deal with the fact that the liquid adhesive requires a certain time during the production process until it has achieved the required firmness, so that the handling with the liquid adhesive alone, especially during a continuous production process, has proven to be difficult.

It is therefore advantageous to unroll a weblike proton-conducting membrane material, provided on a roll, and to transport this in a suitable device to a first applicator tool, with which the liquid adhesive is deposited on one surface of the membrane material. In addition or alternatively, however, the liquid adhesive can also be deposited on a surface of an electrode material, which can also be provided for example on a roll or also as a single piece. After the depositing of the liquid adhesive, the surfaces of the membrane material and the electrode material are placed on top of each other and make a through contact to form a material connection by means of the liquid adhesive. In addition, a production aid is introduced into or applied onto an assemblage formed from the electrode material, the membrane material, and the still unhardened liquid adhesive, the production aid being designed to stabilize the still unhardened assemblage.

In this regard, the production aid for stabilizing the unhardened assemblage is applied in a marginal area situated away from the active region of the membrane electrode assembly. In this way, the production aid is applied away from the active region, i.e., the region in which the fuel cell reaction takes place. In other words, no production aid, so that this does not adversely affect the flow of process gases. Instead, the production aid for stabilizing the unhardened assemblage occurs in the active region. The production aid can be applied in a spot and/or on a surface and/or in a line and it may be an additional joint compound for a material binding of the membrane material and/or the electrode material, yet possessing a shorter hardening time than the liquid adhesive.

The joint compound can be for example a UV-hardening adhesive, the joint compound becoming hardened under UV-light even before the liquid adhesive has hardened. Alternatively or additionally, the joint compound can be a pressure sensitive adhesive in the form of an adhesive tape, being applied away from the liquid adhesive on one or both surfaces of the membrane material or the electrode material. The joint compound can also be a hot melt glue, which is liquefied under the action of heat and hardens once more even before the liquid adhesive has hardened. The joint compound may form a laminate bonding which hardens as such even before the liquid adhesive.

Alternatively or additionally, however, the production aid may also comprise a frame, which is placed on or integrated in the unhardened assemblage, the frame being melted in a spot and/or on a surface and/or in a line, especially by using a laser, and hardening once more even before the liquid adhesive hardens.

The possibility exists for the production aid to remain after the hardening of the liquid adhesive in the now dried assemblage, i.e., in the finished membrane electrode assembly. Yet it is not necessary for the production aid to meet the product requirements demanded of a fuel cell, it only needs to provide the required strength for the handling and thus to ensure the required stabilization of the membrane electrode assembly in the production process. If desired, the production aid can be removed after the production of the membrane electrode assembly, in particular after the hardening of the liquid adhesive and especially after the bonding of the membrane material to a first electrode material on its one side and to a second electrode material on its second side, but it can also remain in the assemblage as long as it does not impair the product properties of the finished (proper) membrane electrode assembly.

On the whole, the embodiments described herein provide the benefit that the production aid is applied immediately before, during, or after the application of the liquid adhesive for the production of the membrane electrode assembly and in the shortest of time it takes over the role of strengthening the membrane electrode assembly until the actual liquid adhesive itself has hardened and thus all the individual components of the membrane electrode assembly have been joined.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for producing an at least two-ply laminate of a membrane electrode assembly for a fuel cell, comprising:
providing a membrane material made of a proton-conductive electrolyte,
providing an electrode material comprising at least one catalyst,
applying a liquid adhesive to a surface of the membrane material and/or on a surface of the electrode material, and
contacting the surfaces of the membrane material and the electrode material to form a firmly bonded connection of using the liquid adhesive, wherein, a production aid is introduced into or applied onto a composite formed from the electrode material, the membrane material and the still uncured liquid adhesive, wherein the production aid is designed to stabilize the uncured composite, wherein the production aid is formed as a joining agent for the firmly bonded connection to the membrane material and/or to the electrode material, which has a shorter curing time compared to the liquid adhesive.

2. The method according to claim 1, wherein the production aid for stabilizing the uncured composite is applied in an edge area remote from an active area of the membrane electrode assembly.

3. The method according to claim 1, wherein the production aid for stabilizing the uncured composite is applied at points and/or flat and/or linearly.

4. The method according to claim 1, wherein the joining agent is an adhesive which can be cured by UV light, and the joining agent is cured with UV radiation before the liquid adhesive has cured.

5. The method according to claim 1, wherein the joining agent is an adhesive in the form of an adhesive tape, which is applied to one or both surfaces away from the liquid adhesive.

6. The method according to claim 1, wherein the joining agent is a hot-melt adhesive which liquefies under the action of heat and cures before the liquid adhesive has cured.

7. The method according to claim 1, wherein the joining agent forms a laminating joint which cures before the liquid adhesive.

8. The method according to claim 1, wherein the production aid comprises a frame which is placed on or integrated into the uncured composite, and that the frame is melted and cured at points and/or flat and/or linearly even before the liquid adhesive cures.

9. The method according to claim 1, wherein the production aid remains in the composite after the liquid adhesive has cured.
